(19) United States
(12) Patent Application Publication
(10) Pub. No.: US 2003/0160814 A1
(43) Pub. Date: Aug. 28, 2003

(54) Slide show presentation and method for viewing same

(76) Inventor: David K. Brown, New York, NY (US)

Correspondence Address: George M. Kaplan, Esq., DILWORTH & BARRESE, LLP, 333 Earle Ovington Blvd., Uniondale, NY, 11553, US

(21) Appl. No.: 10/085,824

(22) Filed: Feb. 27, 2002

(51) Int. Cl. G09G 5/00

(52) U.S. Cl. 345/732

(57) ABSTRACT

A method for interacting with a slide-show presentation, the slide-show including a plurality of slides. A slide is retrieved from among a plurality of slides from a memory storage device. The slide is displayed to a user on a display device at a first resolution. The method provides the user with a capability for performing one or more operations corresponding the displayed slide. The operations include displaying a pop-up text window which provides details about the displayed slide. The operations further include a capability for displaying the slide in a zoom mode, whereby the slide is displayed at an enhanced resolution and a further capability for simultaneously displaying said plurality of slides including said displayed slide in a thumbnail-sketch mode including descriptive text.

### FIELD OF THE INVENTION

The present invention relates to the field of slide-show presentation computer software and, in particular, to methods and systems for viewing and interacting with a slideshow presentation.

### BACKGROUND OF THE INVENTION

Slide presentation programs are computer programs that enable a user to create, edit, manage, and perform “presentations” on a computer. One example of a popular slide presentation program is Microsoft PowerPoint™, available from Microsoft Corporation, of Redmond, Wash. A slide presentation includes electronic “slides,” each slide corresponding to one screen or page of output. An electronic slide may also be converted to a 35 mm slide or overhead transparency and displayed in a standard slide projector or overhead projector. Each slide may contain a still picture or may contain one or more objects, such as text, graphical images, or graphical animation. A slide may also include a sound object that is played when the slide is displayed during a “slide show” performance. A slide presentation program “performs” a “slide show” by sequentially displaying a series of slides contained within the slide presentation. The slides are displayed on a computer screen or projected onto a separate surface. During a performance of a slide show an author of a slide presentation can include slide “timings” with each slide. A slide timing corresponding to a slide indicates the number of seconds that the slide is displayed before the slide presentation program automatically advances to the next slide. That is, the slide presentation program automatically advances to the next slide when the existing slide's timing ends. A typical still slide-show system includes a microcomputer for controlling the order and time period in certain cases for displaying a slide, a magneto-optical disk reproduction apparatus, and a display device. Alternatively, such a presentation can be carried out under user (i.e., viewer) control whereby a user controls the performance by invoking commands to “advance” to the next slide. A command can be entered using a keyboard, a mouse, or other suitable input device. That is, a slide can be switched manually according to the interests of a viewer. A drawback associated with the manual method of viewing slides is that manual operations are restrictive in the sense that a user must advance through the slide presentation in a predetermined sequence with no option for varying the sequence of presentation. A further drawback, which applies equally to the automatic method, is that only a single slide may be viewed at any one time. It would therefore be desirable to have a capability for viewing a plurality of slides simultaneously, and having a further capability for advancing to any slide in the slide sequence in any order.

### SUMMARY OF THE INVENTION

The present invention provides a system and computer-based method for viewing and interacting with a slide-show presentation. The invention may be implemented using standard programming and/or engineering techniques using computer programming software, firmware, hardware or any combination or sub-combination thereof. Any such resulting program(s), having computer readable program code means, may be embodied or provided within one or more computer readable or usable media such as fixed (hard) drives, disk, diskettes, optical disks, CD-ROM, magnetic tape, semiconductor memories such as read-only memory (ROM), etc., or any transmitting/receiving medium such as the Internet or other communication network or link, thereby making a computer program product, i.e., an article of manufacture, according to the invention. The article of manufacture containing the computer programming code may be made and/or used by executing the code directly from one medium, by copying the code from one medium to another medium, or by transmitting the code over a network.

The invention includes features for interacting and viewing a plurality of slides. Such features include an on-demand user selectable pop-up text window for providing on demand text corresponding to a displayed slide. The pop-up text window preferably provides information about a displayed slide which may either repeat what is included in an associated synchronized audio track and/or provide supplemental information in addition what is provided on the audio track.

Another feature of the present invention is directed to a “zoom” or magnification mode in which a displayed slide may be viewed at an enhanced resolution than what is normally displayed. In one embodiment slides are normally displayed in a compressed format. Upon activating the “zoom” or magnification mode, the slide is re-displayed at an enhanced resolution.

A further feature of the present invention is directed to a capability for simultaneously viewing a plurality of slides, referred to herein as the “thumbnail sketch” mode. This “thumbnail sketch” mode provides a user with a capability for quickly viewing a plurality of slides on a display thereby providing a preview capability to the user and further providing ready access to any previewed slide from among the plurality of displayed slides.

According to one aspect of the invention, each of the above described features, are implemented, in a manner in which a user can select/de-select the desired feature by activating the corresponding activation button or icon a second time.

As will readily be appreciated from the foregoing description, a method of viewing and interacting with a slide-show presentation in accordance with the method of the present invention provides a user with enhanced control (i.e., interaction) and viewing options not available in prior art slide show presentation programs. Accordingly, a user's experience is measurably enhanced.

While an embodiment of the invention is described in the context of a virtual museum tour, as a non-limiting example, it is understood that the invention will be applicable in a wide variety of applications. Such applications may include, as non-limiting examples, cataloging, teaching and archiving. Other characteristics and advantages of the present invention will emerge from the description given hereafter with reference to the attached drawings, which illustrate various examples of implementation and embodiments thereof, without any limiting character.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a pictorial diagram illustrating a computer system for implementing the present invention;

FIG. 2 is an exemplary architecture of a computer system for implementing the method of the present invention;

FIG. 3 is a computer screen display of an opening screen of an illustrated embodiment of the present invention;

FIG. 4 is a computer screen display of an embodiment of the present invention illustrating a computer display of a map including hot-links for selecting one or more slide show presentations;

FIG. 5 is a computer screen display of a first slide presented to a user upon selecting a particular slide show presentation from the map of FIG. 4;

FIG. 6 is a computer screen display illustrating a pop-up text window corresponding to the slide of FIG. 5;

FIG. 7 is a computer screen display of the slide of FIG. 5 illustrating the “zoom” mode for the illustrated embodiment of the present invention; and

FIG. 8 is a computer screen display of the “thumbnail sketch” mode for the illustrative embodiment of the present invention.

### DETAILED DESCRIPTION OF THE PREFERRED EMBODIMENT

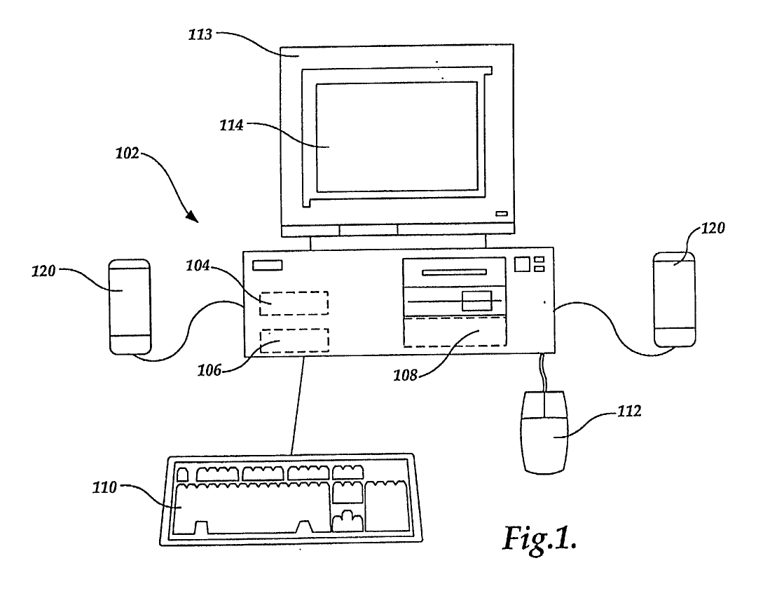

FIG. 1 illustrates a computer system 102 for implementing the present invention. The computer system 102 generally comprises a central processing unit (CPU) 104, an internal memory 106, and a permanent storage medium, such as a disk drive 108. The computer system 102 also includes a keyboard 110 and a pointing device, such as a mouse 112, for entering commands and data into the CPU 104 and a display device 113 such as a monitor to generate a graphical user interface (GUI) that is shown on a display screen 114. Preferably, the computer system 102 further includes circuitry, such as a sound card (not shown), for playing audio signals through an audio output device, such as a set of speakers 120.

An operating system, such as the Windows 98™, 2000™ or the Xp™ operating system as well as other programs, preferably reside in the internal memory 106 well as other programs and execute on the CPU 104. Those skilled in this art, and others, should appreciate that the mechanism of the present invention may be practiced on computer systems with variant architectures. For example, in some architectures a display device projects images onto an associated display screen. Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

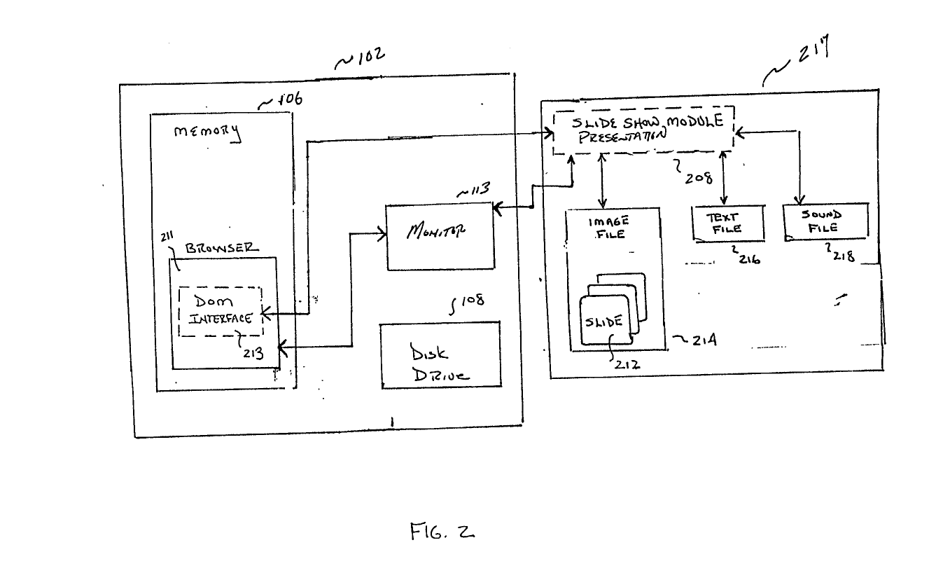

FIG. 2 illustrates the functional relationship of program and data modules used to implement the method of the present invention using the architecture of FIG. 1. Internal memory 106 of computer system 102 stores a browser program 211. The browser program 211 includes a built-in document object module (DOM) interface 213. A slide show presentation module 208 of the present invention may reside on one or more computer readable or usable media such as a fixed (hard) drive, disk, diskettes, optical disks, CD-ROM, magnetic tape, server, client computer, etc. or any combination thereof. The slide show presentation module 208 of FIG. 2 is shown stored on a CD-ROM 217. In general, the computer storage medium may be directly connected to the computer that performs a slide show, or it may be connected to a remote computer on a local area network (LAN) or a wide area network (WAN), such as the Internet. FIG. 2 further illustrates disk drive 108 for receiving CD-ROM 217 and for accessing program code which comprises the slide show presentation module 208 and associated data files. As shown, CD-ROM 217 includes slideshow presentation module 208 containing program code for controlling an electronic slide-show and associated support files including an image file 214, a text file 216 and a sound file 218. The image file 214 contains those images, i.e., “slides” 212, to be displayed to a user during a slide presentation, the sound file 218 contains audio corresponding to the images contained in the image file 214 and the text file 216 includes text corresponding to the displayed images, which are available upon demand by the user. During an electronic slide show, the slide show module 208 retrieves one or more stored slides 212 and displays the slide on an output medium, such as a display monitor 113. Since a slide can contain multimedia data, displaying a slide may include playing audio or video data, as well as visually displaying the contents of the slide.

In the illustrative embodiment, described below, the slide-show module 208 is written in the Javascript programming language and interfaces with an Internet Explorer browser v. 4.0 or higher which includes a Javascript compatible DOM interface. Other browsers compatible with the Internet Explorer browser which provide a DOM interface may be suitable for use. It is noted that the slide-show module 208 may be written in languages other than JavaScript such as, for example, Visual Basic, Vbscript, C, C++, firmware, micro-code, and/or other languages, tools, and combinations thereof. It is also noted that the slide-show module 208 may be cross-platformed providing the host computer includes a browser having a compatible DOM interface. The slide-show module 208 is event driven in that it responds to user events (i.e., inputs) such as mouse clicks, pop-up text window requests and slide navigation requests from the user through the DOM interface 213. According to one aspect of the present invention, the slide show module 208 may be encrypted before being stored onto a storage medium, such as a CD-ROM 217. The Internet Explorer browser v. 4.0 provides a built in de-encrypting capability for decrypting the program code at run time.

The slide show module 208 provides an author with the ability to create and edit one or more “slides” 212, where each slide is a member of a slide set or presentation. A slide is a discreet collection of information, including visual information such as text, graphic images, video, or animation. A slide may also comprise other information, including sounds and interactive information, such as hyperlinks.

The slide-show module 208 provides a capability for presenting an electronic slide show wherein a plurality of slides are grouped into pre-determined slide-show presentations. For example, an electronic slide show may be directed to automobiles. In an automotive slide show, a number of slide presentations are included wherein each slide presentation may be directed to a particular automobile. A first slide presentation may, for example, be directed to a Mercedes Benz, while a second slide presentation may be directed to a Porsche and so on. Each slide show presentation would include one or more slides which comprise a subset of the plurality of slides for illustrating and describing the particular automobile.

In operation, when a user selects a particular slide show presentation from the electronic slide show, the slide-show module 208, in response, retrieves a first slide (image) and associated text and sound data from respective image 214, text 216 and sound 218 data files corresponding to the user selection. In addition, the slide show module 208 may buffer data in the internal memory 106 corresponding to one or more associated slides from the selected slide show presentation. In this manner, by storing only a small subset of slides in the memory 106, the slide presentation, from a user's perspective, is streamlined and memory is preserved. Subsequent to displaying each slide, the slide-show module 208 responds to user activated events via the DOM interface 213. Such user events, may include, for example, moving to a previous/next slide, pausing, stopping or re-starting the slide presentation.

The slide show module 208 of the present invention may display each slide 212 automatically in a predetermined sequence of slides, pausing after displaying each slide until a user performs an operation instructing the slide show module to “advance” by retrieving and displaying the next slide in the sequence of slides. The slide show module 208 also provides the ability for a user to manually override the automatic display presentation by exercising any number of control options to be defined below.

The slide show module 208 also may include an audio narration component (not shown) that controls the playing of audio narration during a slide show performance.

Illustrative Embodiment

In an illustrative embodiment, the slide show presentation program of the present invention will be described in the context of a virtual museum tour. Specifically, an embodiment is described in which a user is provided a capability for conducting a museum tour of historical venues in the city of Venice. The illustrative embodiment provides one example application or field of use for the invention. The utilization of a virtual museum tour in the drawings here is done so for sake of convenience as practical “field or use” application for the invention but it does not, however, limit the applicability of the invention solely to such applications.

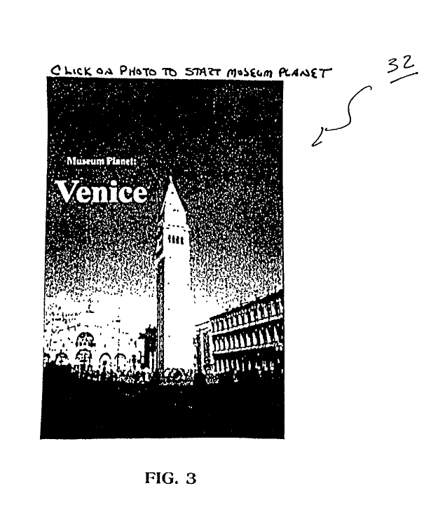

FIG. 3 is a screen display 32 which is presented to the user upon activating the virtual museum slide show presentation program. It is noted that the screen display 32 of FIG. 3 and subsequent screens to be described do not include the standard Windows title bar and system controls for manipulating a window. Further, the screen display 32 also does not contain the standard Windows menu bar for selecting application menu commands.

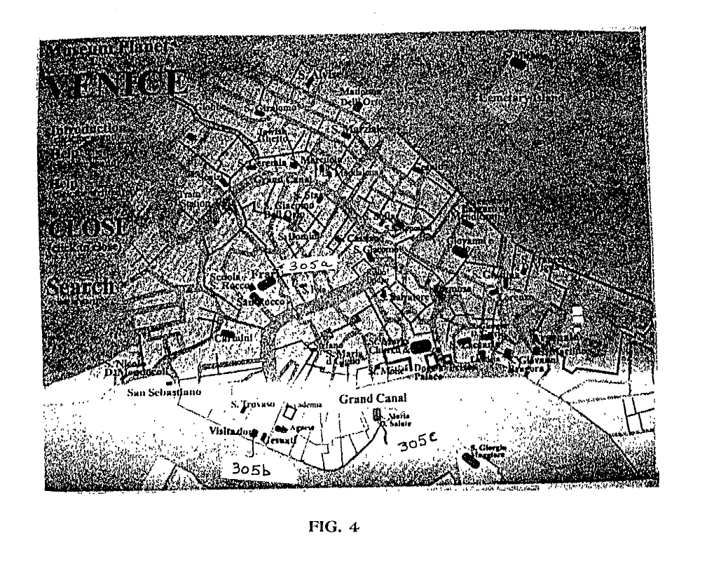

FIG. 4 illustrates a screen which is displayed to a user upon ‘clicking’ on the screen display 32 of FIG. 3. As shown, the screen display of FIG. 4 is a computer display illustrating a map 42 of the city of Venice including a plurality of “clickable” links 305a-c indicating those regions or venues for which a slide show presentation is available to a user. That is, using the mouse, a user is provided a capability for selecting one or more of the venues, i.e., “clickable” links 305a-c, to view a slide-show presentation specific to the selected venue. For example, link 305a is associated with the church of ‘Frari’. The links 305a-c may be recognized by a user by moving the mouse 112 over a designated location on the map 42 and observing that the mouse 112 arrow designation changes from an arrow to a hand. Upon ‘left-clicking’ the desired link 305a-c, the slide show module 208 responsively retrieves a first slide 212 of a pre-stored slide presentation associated with the link, (i.e., selected venue). The slide show presentation then begins by displaying the first retrieved slide of the pre-stored presentation with a corresponding synchronized audio narration. If additional slides exist in the slide presentation, a next slide is automatically retrieved by the slide show module 208 after a predetermined time interval for display. Otherwise, the slide show presentation for the selected venue is complete. At this point, the user has the option of repeating the slide presentation or returning to the map 42 of FIG. 4 to select another venue to view a different slide show presentation.

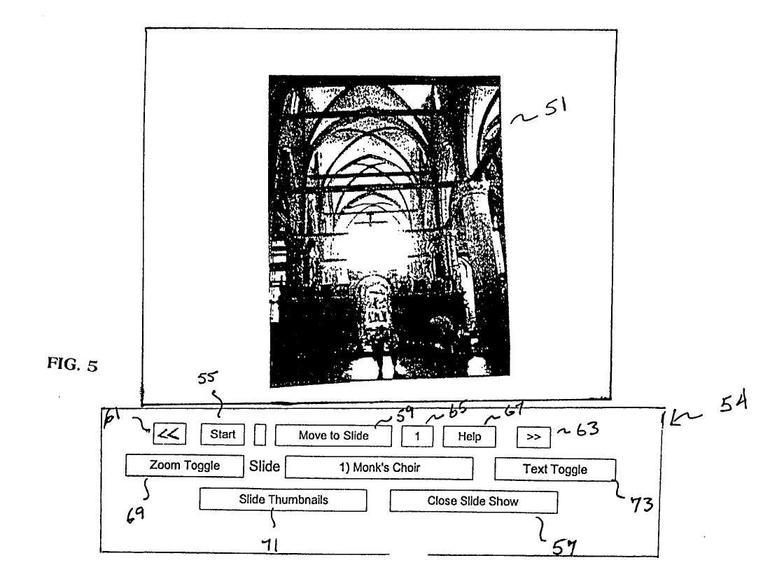

FIG. 5 illustrates an exemplary first slide 51 which may be presented to a user upon selecting a “clickable” hot-link (i.e., selected venue) from the map 42 of FIG. 4. As shown, the first slide 51 fills a substantial majority of the computer display screen 114. Also shown beneath the display of the first slide 51 is the control panel 54 including commands, represented as buttons or icons, for navigating through the slide presentation as well as several display options.

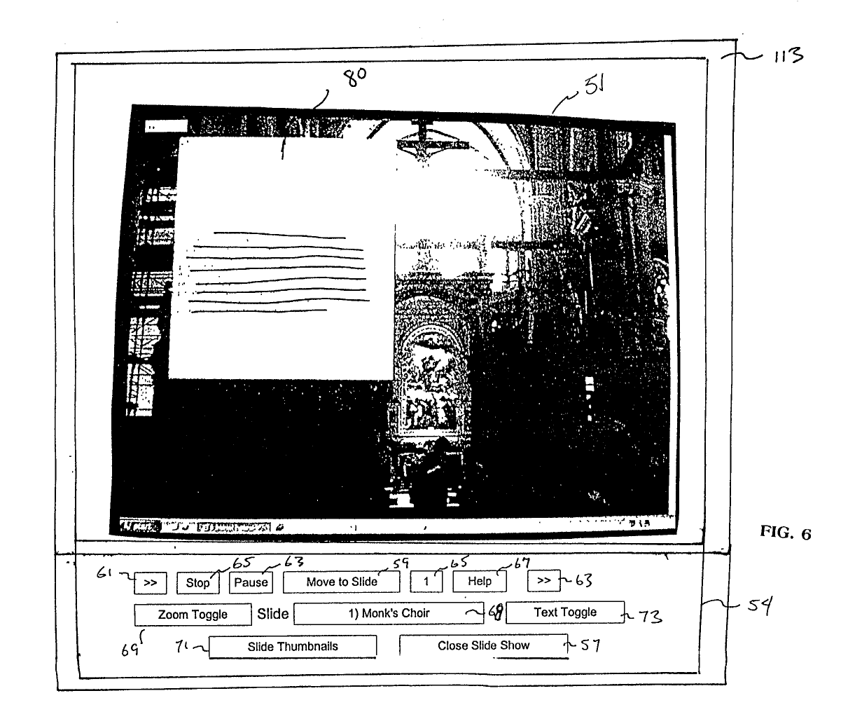

The control panel 54 contains a number of buttons, displayed as icons for navigating a slide show: a “Start” button 55; a “Close Slide Show” 57 button; a “Move to Slide” button 59; a previous slide button 228 depicted as a reverse arrow “<<” button 61; and a next slide button depicted as a forward arrow “”>>” button 63. Selection of the “Start” button 55 causes the slideshow presentation to begin. The “Close Slide Show” button 57 and will return, the viewer to the map 42 of FIG. 4. Selection of the “Move to Slide” button 59 causes the slide presentation program 208 to display the slide corresponding to the slide number entered in the slide number entry box 65. Selection of the previous slide button 61 causes the slide presentation program to display the previous sequenced slide in the slide presentation. Selection of the next slide button 63 causes the slide presentation program to display the next sequenced slide in the slide presentation. A “help” button 67 is shown which when selected will bring up a text pop-window describing the function of each control button on the control panel 54. The control panel 54 further includes a “Zoom Toggle” button 69, a “Text Toggle” button 73 and a “Slide Thumbnails” button 71, each of which are further described below. Upon activation of the slide-show presentation program, certain control buttons are replaced in accordance with the progression of the presentation as shown in FIG. 6. For example, the “Start” button 55 is replaced with “Stop” and “Pause” programs, as shown in FIG. 6.

The slide-show presentation is automated in that each slide is automatically advanced in accordance with a predetermined corresponding timing. However, at any time during the automated slide show presentation, a user may override the automated sequencing of slides by entering a command instructing the slide presentation program 208 to advance to the next slide 212 by selecting the appropriate control from the control panel 54. The slide show presentation preferably includes an audio narration which accompanies each displayed slide.

FIG. 6 illustrates one feature of the present invention. FIG. 6 illustrates a pop-up text window 80 which appears on the display screen 113, in response to the user activating the “Text Toggle” button 73. The pop-up text window 80 preferably includes additional details concerning the displayed slide (e.g., slide 51 of FIG. 5) not available from the audio narration. For example, the pop up text window 80 may provide details concerning an artist's biography. A user may at any point remove the pop-up text window 809 from the display screen 113 by ‘left-clicking’ the “Text toggle” button 73 a second time.

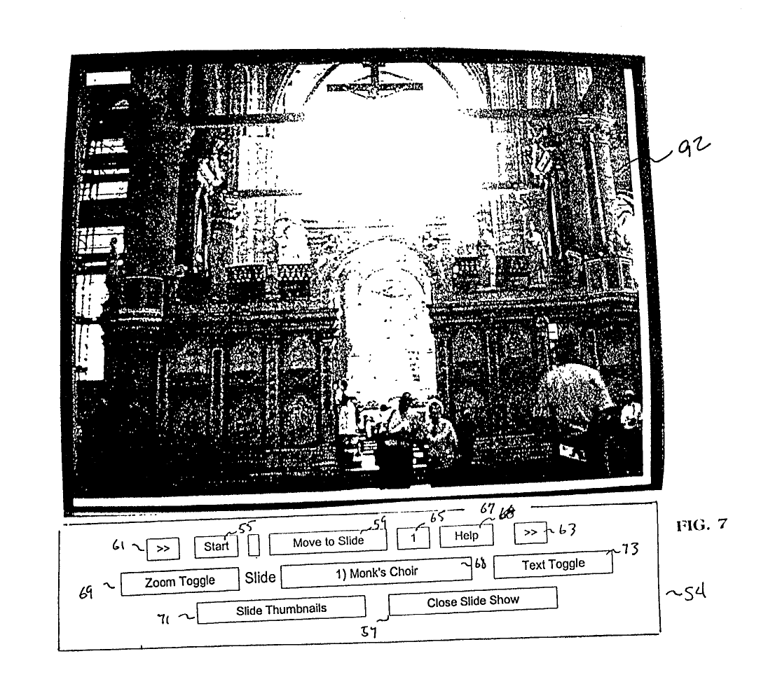

FIG. 7 illustrates another feature of the present invention. FIG. 7 illustrates a capability for magnifying a displayed slide 212 at an enhanced resolution. In the illustrative embodiment, by selecting the “Zoom Toggle” button 69, a displayed slide is displayed at a maximum resolution on the order of 96 dots per inch which constitutes a maximum display dimension. FIG. 7 illustrates the slide 51 of FIG. 5 magnified in the zoom mode as a magnified slide 92. As shown, the zoom feature oversizes the normally displayed slide 51 to provide a user with a better sense of the scale of viewed objects. In the zoom mode, the magnified slide 92 can be panned in both the horizontal and vertical directions by using the horizontal and vertical scroll bars, respectively (not shown). ‘Left-clicking’ the “Zoom Toggle” button 69 a second time on either the control panel 54 or by ‘right-clicking’ the mouse 112 to display a proprietary drop-down menu will reduce the magnified slide 92 to its originally displayed size 51. It is noted that the proprietary drop-down menu (not shown) can be accessed in most display modes to provide some of the functionality included in control panel 54.

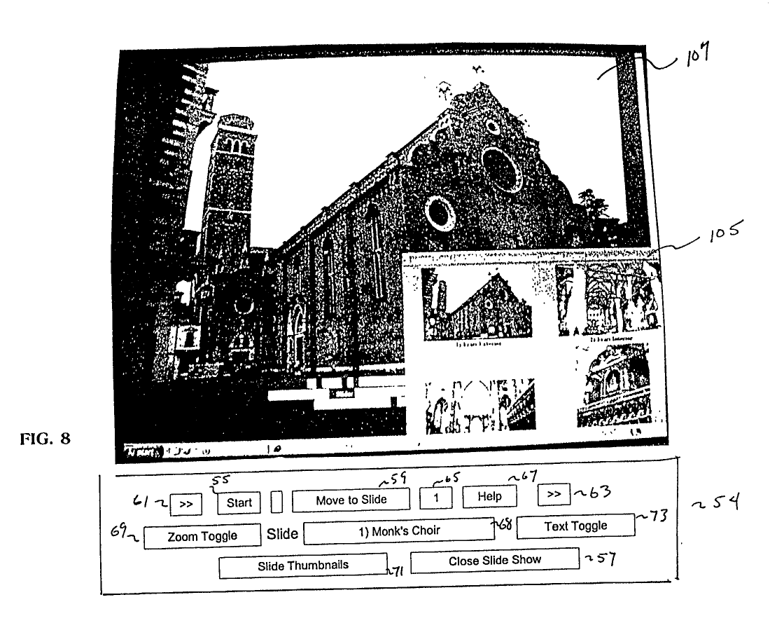

FIG. 8 illustrates another feature of the present invention. FIG. 8 illustrates a capability for providing a thumbnail sketch of a sequence of related slides which make up a slide presentation. This feature provides a user with an on demand capability for simultaneously previewing every slide 212 in a particular slide presentation. FIG. 8 illustrates what a user is shown upon “left-clicking” the “Slide Thumbnails” button 71 on the control panel 54. This thumbnail sketch mode is also accessible via a proprietary pop-up menu upon ‘right-clicking’ the mouse. As shown, a thumbnail-sketch 601 window 105 is generally displayed above the currently displayed slide 107. The window may be translated or re-sized in accordance with a user's preference.

The thumbnail sketch window 105 provides an on demand visual and written index of a currently selected slide presentation. While in this mode, the user may ‘left click’ on any displayed slide in the thumbnail-sketch window 105 and will be shown a full size display of the selected slide similar to what is shown in FIG. 5. Upon selecting a particular thumbnail sketch slide, the selected slide is re-displayed at a normal resolution, as shown in FIG. 5. At this point, the slide presentation may continue in the normal manner as described with reference to FIG. 5. The number of thumbnail sketches (i.e., slides) displayed in the thumbnail sketch window 105 will depend upon the particular slide show presentation selected. The number of thumbnail sketches may be enough to partially or completely fill a display screen, or even greater than that. Where the number of thumbnail images exceeds the space provided by the screen, a paging or scrolling feature may be provided. Responsive to user mouse clicks or the like, the displayed thumbnails may be scrolled by row, by page, etc.

Other Embodiments

The present invention provides a method for viewing a slide-show which may include still pictures, graphics, animation, abbreviated video sequences, etc in any combination. The method of the present invention finds applicability in a wide variety of applications by virtue of its novel features which include on demand zoom, thumbnail slide capability and pop-up text windows. One exemplary application is the area of cataloging. Using the zoom feature, a customer would have a capability for analyzing details such as texture, condition and color of catalogue items in an unprecedented fashion. The zoom feature maintains the clarity of the normally displayed object by projecting a zoomed image that is larger than the screen dimensions. The displayed object can then be easily scrolled over using the horizontal and vertical scroll bars. The pop-up text window feature may provide numerous details about each cataloged item on a need to know basis. This is an efficient means of relaying information in that a user is not unnecessarily subjected to more information than he or she requires. Rather, a user can elect to learn more about only those catalogued items of interest via the pop-up text window. The visual thumbnail feature, which is available on demand throughout a slide show. The thumbnails offer a combined visual/written index on demand. Simply by clicking on the thumbnail feature, a user is provided with a capability for simultaneously viewing a plurality of catalogued items. In this manner, a particular catalogued item of interest may be rapidly identified and accessed.

Another application area of the present invention is teaching or learning. The on demand pop-up text and zoom features could radically simplify complex training manual procedures by providing a user with an unprecedented capacity for viewing, in its most intimate details, complex assemblies, such as, for example, complex electronic and mechanical assemblies. Further, the combination of audio narration and pop-up text windows essentially make a wealth of technical information available to a user on demand.

Conclusion

One skilled in the art of computer science will easily be able to combine the software created as described with appropriate general purpose or special purpose computer hardware to create a computer system and/or computer subcomponents embodying the invention and to create a computer system and/or computer subcomponents for carrying out the method of the invention. While the preferred embodiment of the present invention has been illustrated in detail, it should be apparent that modifications and adaptations to that embodiment may occur to one skilled in the art without departing from the spirit or scope of the present invention as set forth in the following claims.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A method for interacting with a slide-show presentation, the slide-show including a plurality of slides, the method comprising the steps of:
retrieving a slide from among said plurality of slides from a memory storage device;
displaying said retrieved slide on a display device at a first resolution;
performing one or more operations corresponding to said displayed slide, said one or more operations selected from the group consisting of displaying a first graphical user interface (GUI) window on said display device, said first GUI window including text corresponding to the displayed slide; displaying a subsequent electronic image of the displayed slide in a second GUI window on said display device, said subsequent electronic image comprising an enlarged portion of the displayed slide at a second resolution and simultaneously displaying said plurality of slides including said displayed slide in a third GUI window at a third resolution on said display device.

2. The method of claim 1, wherein the one or more operations are performed in response to a display command invoked by a user.

3. The method of claim 2, wherein the display command is performed via one of a corresponding command icon displayed on said display device concurrent with said displayed slide and a pop-up text menu.

4. The method of claim 3, wherein said pop-up text menu is accessed via a computer pointing device.

5. The method of claim 1, further comprising the step of selecting one of said simultaneously displayed plurality of slides, displayed at said third resolution for display at said first resolution.

6. The method of claim 1, wherein said simultaneously displayed plurality of slides are displayed in a thumbnail-sketch format.

7. The method of claim 1, wherein said plurality of slides including said displayed slide displayed in said third GUI window at said third resolution on said display device further comprise displaying text corresponding to each of said plurality of slides.

8. The method of claim 1, further comprising the step of selecting one of said plurality of slides for display from a drop-down text menu on said display device.

9. The method of claim 8, wherein said drop-down text menu comprises a plurality of descriptive titles, each title corresponding to one of said plurality of slides.

10. A method for interacting with a slide-show presentation, the slide-show including a plurality of slides, the method comprising the steps of:
retrieving a slide from among said plurality of slides from a memory storage device;
displaying said retrieved slide on a display device at a first resolution;
displaying a plurality of command icons on said display device for performing navigation control and display functions;
displaying a first graphical user interface (GUI) window displaying text corresponding to the displayed slide in response to a first display command;
displaying a subsequent electronic image of said displayed slide in a second GUI window comprising an enlarged portion of the displayed slide at a second resolution in response to a second display command; and
simultaneously displaying a plurality of slides including said displayed slide in a third GUI window on said display device in response to a third display command.

11. The method of claim 10, wherein the plurality of icons for performing navigation control functions include control functions to access said plurality of slides in one of a sequential and non-sequential order.

12. A computer-readable medium storing a presentation program module comprising computer-executable instructions which, when executed by a computer system cause the computer system to perform the steps of:
retrieving a slide from among said plurality of slides from a memory storage device;
displaying said retrieved slide on a display device at a first resolution;
displaying a plurality of command icons on said display device for performing navigation control and display functions;
displaying a first graphical user interface (GUI) window displaying text corresponding to the displayed slide in response to a first display command;
displaying a subsequent electronic image of said displayed slide in a second GUI window comprising an enlarged portion of the displayed slide at a second resolution in response to a second display command; and
simultaneously displaying a plurality of slides including said displayed slide in a third GUI window on said display device in response to a third display command.

13. The computer readable medium of claim 12, wherein the one or more operations are performed in response to a display command invoked by a user.

14. The computer readable medium of claim 12, wherein the display command is performed via one of a corresponding command icon displayed on said display device concurrent with said displayed slide and a pop-up text menu.

15. The computer readable medium of claim 12, wherein said pop-up text menu is accessed via a computer pointing device.

16. The computer readable medium of claim 12, further comprising the step of selecting one of said simultaneously displayed plurality of slides, displayed at said third resolution for display at said first resolution.

17. The computer readable medium of claim 12, wherein said simultaneously displayed plurality of slides are displayed in a thumbnail-sketch format.
